(19) United States
(12) Patent Application Publication
(10) Pub. No.: US 2010/0001881 A1
(43) Pub. Date: Jan. 7, 2010

(54) METHOD OF ADJUSTING DISPLAY DEVICE FOR VEHICLE AND DISPLAY DEVICE FOR VEHICLE

(75) Inventors: Shinichi Sugie, Tsurugashima-shi (JP); Naohiko Ichihara, Tsurugashima-shi (JP); Hiroto Inoue, Tsurugashima-shi (JP); Osamu Yamazaki, Tsurugashima-shi (JP); Junya Ochi, Kawagoe-shi (JP); Kouichi Sugano, Kawagoe-shi (JP)

Correspondence Address: YOUNG & THOMPSON, 209 Madison Street, Suite 500, Alexandria, VA, 22314, US

(73) Assignee: PIONEER CORPORATION, Tokyo (JP)

(21) Appl. No.: 12/523,012

(22) PCT Filed: Jan. 16, 2007
(86) PCT No.: PCT/JP2007/050500

§ 371 Date: Aug. 4, 2009

(51) Int. Cl. B60Q 1/48; G09G 5/00

(52) U.S. Cl. 340/932.2; 345/647

(57) ABSTRACT

A vehicular display device adjustment method including an imaging step of taking an image of the periphery of a vehicle by imaging element, an image storing step of temporarily storing in an image storing element peripheral image data based on the peripheral image of the vehicle taken by the imaging element, a setting step of setting an adjustment mode for adjusting the display state of display element, a display control step of giving priority to the peripheral image based on the peripheral image data stored in the memory over the peripheral image taken in the imaging step in accordance with the adjustment mode set and displaying on the display element the peripheral image based on the peripheral image data stored in the memory, and an adjustment step of adjusting the display state of the display element based on the peripheral image.

### CROSS-REFERENCE TO RELATED APPLICATION

This is an application PCT/JP2007/50500, filed Jan. 16, 2007, which was not published under PI article 21(2) in English.

### BACKGROUND OF THE INVENTION

1. Field of the Invention

The present invention relates to a vehicular display device adjustment method and vehicular display device for taking an image of the periphery of a vehicle and displaying the peripheral image of the vehicle inside the vehicle.

2. Description of the Related Art

The vehicles (hereinafter “automobiles” as an illustrative example) of recent years are sometimes provided with a camera for checking the view behind the vehicle. Such vehicles of recent years have a function (hereinafter “rearward display function”) for displaying on a display device inside the vehicle a rearward image taken by that camera when backing up, for example. This rearward display function displays on the display device inside the vehicle a rearward image taken by a camera disposed outside the vehicle, at the rear.

The automobiles of recent years utilize the driver's act of setting the shift lever to a predetermined position to back up, for example, as a trigger to display on a display device inside the vehicle a rearward image taken by the camera. The driver can visually check the view behind the vehicle, which is normally difficult to see, by such a rearward display function using the display device (equivalent to a vehicular display device) inside the vehicle.

One such a display device is a device that comprises image display adjusting means configured to adjust display settings in order to further improve the display state. This display device of prior art comprises assessing means such as that described below, which includes a device startup detecting unit and a signal change detecting unit. The device startup detecting unit has a function that detects whether or not a change has occurred in an input signal based on startup of the display device. On the other hand, the signal change detecting unit has a function that detects a change in that input signal. The assessing means is designed so as to enable execution of the image display adjusting means configured to automatically or manually adjust display settings based on that input signal (refer to JP, B, 3829873, for example).

### SUMMARY OF THE INVENTION

### Problem to be Solved by the Invention

Nevertheless, while the image display adjusting means adjusts the display state based on the input signal inputted at the present point in time in the above-described prior art, it is difficult to mount such an image display adjusting means in a vehicular display device and adjust the display state in real-time. Such difficulty arises because the vehicular display device is used when the vehicle is moving, and adjusting such a display state in a moving vehicle may hinder safe driving.

The above-described problem is given as one example of the problems that are to be solved by the present invention.

### Means of Solving the Problem

To achieve the object the invention of claim 1 comprising: an imaging step of taking an image of the periphery of a vehicle at a particular position using an imaging unit; at a particular position where the vehicle is to start backing up toward a parking space that exists behind the vehicle; an image storing step of temporarily storing in an image storing unit peripheral image data based on a peripheral image of the vehicle taken by the imaging unit; a setting step of setting an adjustment mode for adjusting a display state of a display unit; a display control step of giving priority to the peripheral image based on peripheral image data stored in the image storing unit over the peripheral image taken in the imaging step in accordance with the adjustment mode set and displaying the peripheral image based on the peripheral image data stored in the image storing unit on the display unit; and an adjustment step of adjusting a display state achieved of the display unit based on the peripheral image wherein: the adjustment step selectively executes a subsequent adjustment mode where, after an image of the periphery of the vehicle has been taken by the imaging unit, the vehicle is moved from the particular position to a desired position located at a predetermined distance away from the particular position where display adjustment of the adjustment step is performed, and an immediate adjustment mode where, after an image of the periphery of the vehicle has been taken by the imaging unit, display adjustment of the adjustment step is performed at the particular position as is.

To achieve the object, the invention of claim 5 comprising: an imaging unit configured to take an image of the periphery of a vehicle at a particular position where the vehicle is to start backing up toward a parking space that exists behind the vehicle; an image storing unit configured to temporarily store peripheral image data based on a peripheral image of the vehicle taken by the imaging unit; an adjusting unit configured to adjust a display state of a display unit; a setting unit configured to set an adjustment mode of the adjusting unit; and a display control unit configured to give priority to the peripheral image based on peripheral image data stored in the image storing unit over the peripheral image taken by the imaging unit in accordance with the adjustment mode set and perform control so as to display the peripheral image based on the peripheral image data stored in the image storing unit on the display unit, wherein: the adjustment unit selectively executes a subsequent adjustment mode where, after an image of the periphery of the vehicle has been taken by the imaging unit, the vehicle is moved from the particular position to a desired position located at a predetermined distance away from the particular position where display adjustment is performed, and an immediate adjustment mode where, after an image of the periphery of the vehicle has been taken by the imaging unit, display adjustment is performed at the particular position as is.

### BRIEF DESCRIPTION OF THE DRAWINGS

FIG. 1 is a conceptual view showing a configuration example of a vehicle where a vehicular display device of the present embodiment is mounted.

FIG. 2 is a flowchart illustrating an example of normal operation of the vehicular display device.

FIG. 3 is a flowchart illustrating an example of the adjustment method of the vehicular display device.

FIG. 4 is an image view illustrating an example of a state where the vehicular display device is adjusted.

### DETAILED DESCRIPTION OF THE PREFERRED EMBODIMENTS

The following describes an embodiment of the present invention with reference to accompanying drawings.

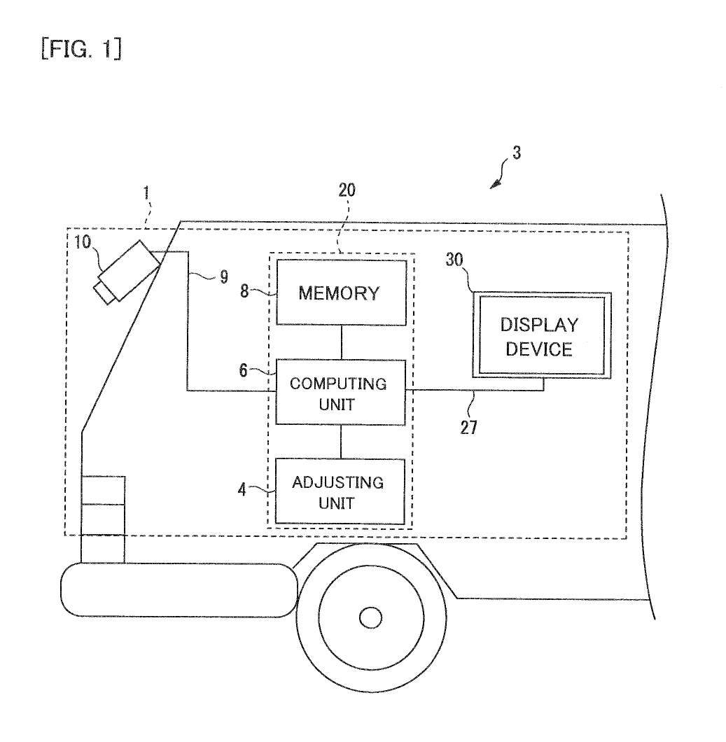

FIG. 1 is a conceptual view showing a configuration example of a vehicle 3 where a vehicular display device 1 of the present embodiment is mounted.

The vehicle 3 is an automobile, for examples and is capable of moving forward and backward and turning left and right according to an operation performed by the driver. This vehicular display device 1 is provided with an imaging device 10 (hereinafter “camera 10”), an image generating unit 20, and a display device 30.

The camera 10 is a so-called digital camera that employs a charge-coupled device (CCD), for example. The camera 10 (imaging unit) has a function that takes, as one example of the periphery of the vehicle 3, a rearward image at a particular position described later. Furthermore, this camera 10 may have a function that takes at least one of a sideways image of the vehicle 3 and frontward image of the vehicle 3 in addition to or in place of the rearward image of the vehicle 3. This embodiment describes as an example a case where the camera 10 takes a rearward image of the vehicle 3. The camera 10, based on an image of the view behind the vehicle 3 (hereinafter “rearward image”), outputs rearward image data 9. The camera 10 takes images using a wide-angle lens, for example, in order to capture the view behind the vehicle 3 at a wider angle. The image taken by this camera 10 is sometimes somewhat distorted due to the effect of using a wide-angle lens.

The image generating unit 20 is connected to the camera 10 and the display device 30. This image generating unit 20 generates display data 27 for displaying a rearward image of the vehicle 3, based on the rearward image data 9 inputted from the camera 10. Furthermore, the image generating unit 20 outputs the generated display data 27 to the display device 30. The image generating unit 20 may also perform image processing such as distortion correction and viewpoint conversion on the rearward image of the vehicle 3 based on the inputted rearward image data 9.

The display device 30 has a function that executes display in a display mode based on the display data 27 received from the image processing device 20. Specifically, the display device 30 (display unit) has a function that displays the rearward image of the vehicle 3 based on the rearward image data 9 stored in a memory 8 described later. This display device 30 is a display such as a liquid crystal display device provided inside the vehicle 3, for example. This display device 30 is capable of serving as a display device of a navigation system that provides guidance with regard to a route that should be taken, and as a display device of a television receiver, for example.

The image generating unit 20 comprises a computing unit 6, an adjusting unit 4, and the memory 8.

The memory 8 (image storage unit) has a function that temporarily stores the rearward image data 9 based on the rearward image of the vehicle 3 taken by the camera 10 according to the control of the computing unit 6. This memory 8 is a flash memory, for example.

The computing unit 6 has a function that generates the display data 27 based on that rearward image data 9. The computing unit 6 has a function that sets the adjustment mode for adjusting the display state of the display device 30. This function will be described in detail later. The computing unit 6 (display control unit) gives priority a peripheral image based on the rearward image data 9 stored in the memory 8 over the rearward image (peripheral image) taken by the camera 10 in accordance with the set adjustment mode, and performs control so as to display the peripheral image based on the rearward image data 9 stored in the memory 8 on the display device 30.

The adjusting unit 4 (adjusting unit) has a function that adjusts the display state of the display device 30 after the vehicle 3 is moved from a particular position to a desired position after the image has been taken by the camera 10, for example. Specifically, the adjusting unit 4 has a function that adjusts the display state of the display device 30 based on the rearward image of the vehicle 3 displayed on the display device 30. Furthermore, in a case where the camera 10 takes at least one of the sideways image of the vehicle 3 and the frontward image of the vehicle 3 in addition to or in place of the rearward image of the vehicle 3 as described above, the adjusting unit 4 may adjust the display of any one of these peripheral images.

With the vehicular display device 1 comprising a configuration such as described above, an example of the normal operation and an example of the adjustment method of the vehicular display device 1 will now be described with reference to FIG. 1.

### Operation Example

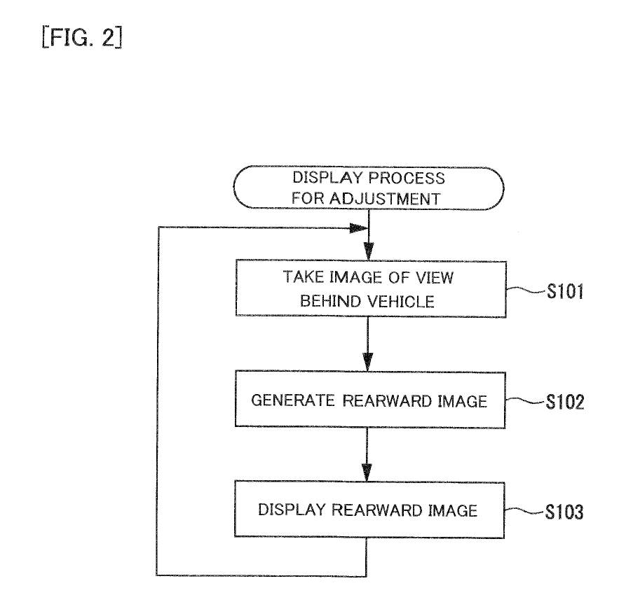

FIG. 2 is a flowchart illustrating an example of the normal operation of the vehicular display device 1.

First, in step S101, the camera 10 shown in FIG. 1 takes an image of the view behind the vehicle 3. This camera 10 outputs the rearward image data 9 based on the rearward image of the vehicle 3 to the image generating unit 20.

Next, in step S102, the image generating unit 20 generates the display data 27 for displaying the rearward image of the vehicle 3 on the display device 30, based on the rearward image data 9 inputted from the camera 10. The image generating unit 20 outputs the generated display data 27 to the display device 30. Next, in step S103, the display device 30 executes display using a display mode based on the display data 27 received from the image generating unit 20.

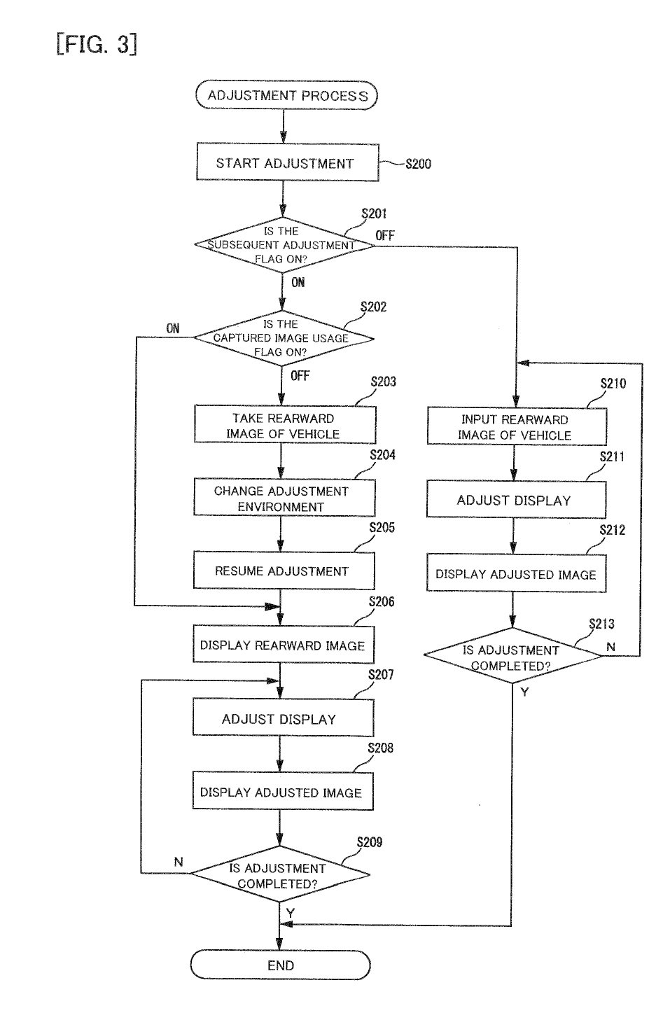

FIG. 3 is a flowchart illustrating an example of the adjustment method of the vehicular display device 1. In this embodiment, there are two types of adjustment methods of the vehicular display device 1: one is referred to as “immediate adjustment mode” and the other as “subsequent adjustment mode.” Here, in this embodiment, the person (user, for example) who maintains the vehicle 3 selects and sets immediate adjustment mode or subsequent adjustment mode as the adjustment method of the vehicular display device 1. In this embodiment, the flag that manages the setting that indicates whether the mode is immediate adjustment mode or subsequent adjustment mode is referred to as the “subsequent adjustment flag.” This subsequent adjustment flag indicates that the mode is immediate adjustment mode when the value is “0” and subsequent adjustment mode when the value is “1.” In such a display adjustment step, the adjusting unit 4 selectively executes the immediate adjustment step and subsequent adjustment mode in accordance with the setting of the subsequent adjustment flag. While the details will be described later, this adjusting unit 4 later sets the mode to immediate adjustment mode or subsequent adjustment mode in accordance with this subsequent adjustment flag since the adjustment mode is not initially set.

Furthermore, in this embodiment, in subsequent adjustment mode, the image that should be displayed during display adjustment after the vehicle 3 has been moved from a particular position to a desired position can be set according to a captured image usage flag. Specifically, it is possible to provide as this image an already taken peripheral image at the above-described particular position, or a peripheral image taken at a desired position, which is the move destination. In this embodiment, the computing unit 6 uses the peripheral image already taken at the particular position when the captured image usage flag is ON, and provides a peripheral image taken at the desired position, which is the move destination, when the captured image usage flag is OFF.

First, in step S200, the vehicular display device 1 starts adjustment. The computing unit 6, triggered by an operation performed by the user, for example, outputs an adjustment start signal to the adjusting unit 4 indicating that the adjustment operation should be started. The adjusting unit 4, triggered by receipt of the adjustment start signal from the computing unit 6, starts the adjustment operation such as follows.

Next, in step S201, the adjusting unit 4 checks the set subsequent adjustment flag. This adjusting unit 4 sets the adjustment mode to subsequent adjustment mode and executes step S202 when the subsequent adjustment flag is ON, and sets the adjustment mode to immediate adjustment mode and executes step S210 when the subsequent adjustment mode is OFF.

### <Subsequent Adjustment Mode>

In subsequent adjustment mode, after an image of the area behind the vehicle 3 has been taken by the camera 10, the vehicle 3 is moved from that particular position to a desired position, and then the adjusting unit 4 performs display adjustment. Specifically, first in step S202, the computing unit 6 sets the adjustment mode for adjustment of the display state of the display device 10 (setting step). In this step S202, the computing unit 6 assesses whether or not the captured image usage flag is ON. The computing unit 6 executes step S206 described later when the captured image usage flag is OFF, and executes step S203 when the captured image usage flag is ON.

In step S203, the camera 10 takes an image of the view behind the vehicle 3 at a particular position (imaging step). That is, during imaging, the vehicle 3 is positioned in a location (equivalent to the above particular position) having a landscape that enables easy adjustment of the display of the vehicular display device 1. Here, a location where the vehicle 3 should back up and enter a parking space is given as an example of a particular position. At such a particular position, traffic of other vehicles exists, making the area not particularly safe, resulting in the need to perform display adjustment in a short period of time.

Furthermore, in this step S203, the camera 10 outputs the rearward image data 9 to the image generating unit 20 based on the rearward image of the vehicle 3. In the image generating unit 20, the computing unit 6 temporarily stores the rearward image data 9 based on the rearward image of the vehicle 3 taken by the camera 10 in the memory 8 (image storing step).

Next, in step S204, the adjustment environment is changed. Specifically, after an image has been taken by the camera 10, the vehicle 3 is moved from the particular position where the view behind the vehicle 3 was taken by the camera 10 to a position (desired position) suitable for display adjustment (movement step). In this embodiment, the vehicle 3 is moved from a particular position to a position other than the particular position as an illustrative example. Examples of the movement destination include a location where it is safe to park the vehicle 3 for a while in order to perform display adjustment.

Next, in step S205, the vehicular display device 1 resumes display adjustment as follows. First, the computing unit 6, triggered by an operation performed by the user, for example, outputs an adjustment start signal to the adjusting unit 4 indicating that the adjustment operation should be started. The adjusting unit 4, triggered by receipt of the adjustment start signal from the computing unit 6, resumes the adjustment operation such as follows. That is, the computing unit 6 displays on the display device 30 the rearward image of the vehicle 3 based on the rearward image data stored in the memory 8 (display step).

On the other hand, in step S206, the computing unit 6 of the image generating unit 20 reads the rearward image data 9 stored in the memory 8, generates the display data 27 based on this rearward image data 9, and outputs the generated display data 27 to the display device 30. What is, for example, in accordance with the adjustment mode set by the captured image usage flag (when the captured image usage flag is ON, for example), the computing unit 6 gives priority to a peripheral image based on the rearward image data 9 stored in the memory 8 over the rearward image captured by the camera 10 in the above-described imaging step and performs control so as to display the peripheral image based on the rearward image data 9 stored in the memory 8 on the display device 10 (display control step).

Next, in step S207, the adjusting unit 4 adjusts the display state of the display device 1 based on the rearward image (also referred to as “adjusted image” in this embodiment) of the vehicle 3 displayed on the display device 30 (display adjustment step). Examples of specific content of display adjustment performed by the adjusting unit 4 include, for example, correction of the distortion (skew, parallel, rotation, etc.) of the rearward image of the vehicle 3 displayed on the display device 30, correction of the display state (color, brightness, contrast) of the rearward image of the vehicle 3 displayed on the display device 30, and adjustment of the settings, zoom settings, or focus of the camera 10, or a combination thereof.

Next, in step S208, the computing unit 6 of the image generating unit 20 displays on the display device 30 the display state based on the rearward image data 9 after adjustment by the adjusting unit 4. In the next step S209, the adjusting unit 4 of the image generating unit 20 assesses whether or not such display adjustment should be ended, and executes step S207 when such display adjustment should not be ended, and ends processing when such display adjustment should be ended.

### <Immediate Adjustment Mode>

In immediate adjustment mode, after an image of the view behind the vehicle 3 has been taken by the camera 10, the adjusting unit 4 performs display adjustment at that particular location as is. Specifically, in step S202, the adjusting unit 4 first executes step S210 when the subsequent adjustment flag is ON (when the mode is immediate adjustment mode). In this step S210, after an image of the view behind the vehicle 3 has been taken by the camera 10, the adjusting unit 4 performs display adjustment at that particular position as is (that is, without the vehicle 3 being moved from that particular position to a safe, desirable position). Specifically, in the step S210, the computing unit 6 inputs the rearward image data 9 from the camera 10. This computing unit 6 generates the display data 27 based on the rearward image data 9, and outputs the generated display data 27 to the display device 30. Then, in step S211, the display device 30 displays the rearward image of the vehicle 3 based on this rearward image data 9.

Subsequently, in step S211, the adjusting unit 4 of the image generating unit 20 performs adjustment based on the display state of the rearward image of the display device 30. Next, in step S212, the computing unit 6 displays the display data 27 on the display device 30 based on the adjusted image after adjustment by the adjusting unit 4. Next, in step S213, the computing unit 6 assesses whether or not display adjustment should still be performed by the adjusting unit 4. This computing unit 6 executes step S210 when display adjustment should not be ended, and ends adjustment processing when display adjustment should be ended.

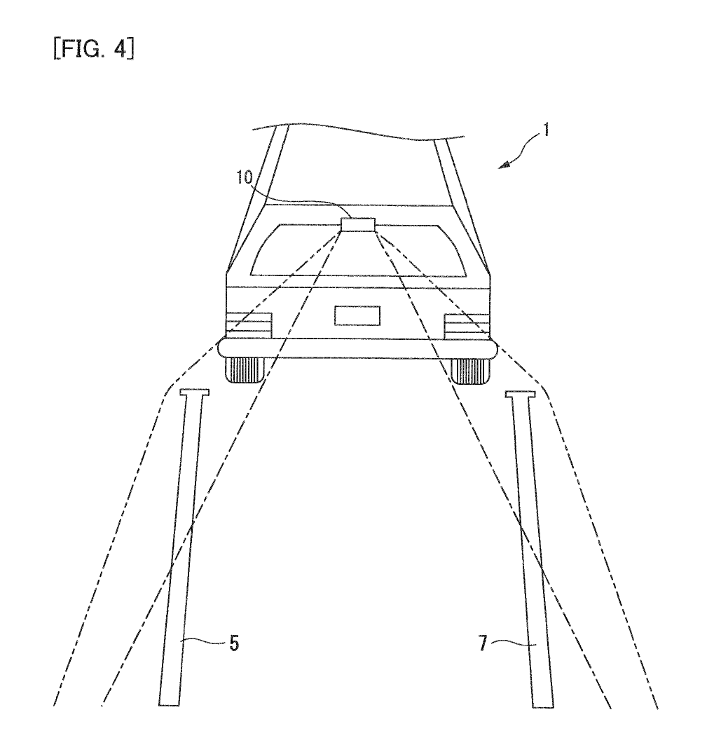

FIG. 4 is an image view illustrating an example of a state where adjustment of the vehicular display device 1 is performed. The dashed-two dotted line in the figure indicates the range of the road surface of the parking lot that can be captured by the camera 10, and the dashed-one dotted line indicates the range of the space above the road surface of the parking lot that can be captured by the camera 10.

This example assumes a case where the vehicle 3 is to be parked in a parking lot, and shows a state where the vehicular display device 1 is adjusted. In this parking lot exists parking space lines 5 and 7 as guides for a parking space for the vehicle 3. The parking space lines 5 and 7 are drawn on the road surface of the parking lot so as to be mutually parallel at an interval somewhat wider than the width of the vehicle 3.

Here, the vehicle 3 is stopped near the entrance rather than inside the region of the parking space enclosed by the parking space lines 5 and 7. Generally, each parking space area inside the parking lot is filled by another parked vehicle, making the parking lot safer than a road. Nevertheless, at the entrance of such a parking space, the vehicle 3 may hinder the traffic of other vehicles attempting to park in other parking space areas, thereby making the attempt to park the vehicle 3 while executing adjustments that require a certain amount of time not only a hindrance for the other vehicles, but unsafe for the vehicle 3 as well.

In this embodiment, when the vehicular display device 1 is set to subsequent adjustment mode, the vehicle 3 temporarily stops in a position such as shown in FIG. 4, where, within a short period of time, adjustment preparation is performed by the vehicular display device 1 as described above. The adjustment preparation performed here refers to the camera 10 of the vehicular display device 1 taking an image of the area behind the vehicle 3, and does not include the adjustment itself that is based on that rearward image.

Here, the camera 10 is mounted on the upper rear area of the vehicle 3 as described above, and is capable of taking an image of the area behind the vehicle 3 within the capturable range. The capturable range of this camera 10 includes the above-described parking space lines 5 and 7. In a case where the camera 10 is mounted in the correct position on the vehicle 3, the rearward image of the vehicle 3 taken by the camera 10 is displayed normally without distortion of the parking space lines 5 and 7. Then the vehicle 3 is moved from such an unsafe location to a safe location where, under a preferred relaxed adjustment environment, the above-described adjustment is performed.

The adjustment method of the vehicular display device 1 of the above embodiment comprises an imaging step of taking an image of the periphery of the vehicle 3 using the imaging unit 10 (camera) at a particular location, an image storing step of temporarily storing in the image storage unit 8 (memory) the peripheral image data 9 (rearward image data) based on the peripheral image (rearward image, for example) of the vehicle 3 taken by the imaging unit 10 (camera), a setting step of setting the adjustment mode for adjusting the display state of the display unit 30, a display controlling step of giving priority to peripheral image based on the peripheral image data 9 stored in the image storing unit 8 over the peripheral image taken in the imaging step in accordance with the adjustment mode set and displaying that peripheral image based on the peripheral image data 9 stored in the image storing unit 8 on the display unit 30, and an adjustment step of adjusting the display state of the display unit 30 based on that peripheral image.

Normally, the vehicular display device 1 takes an image of the periphery of the vehicle 3 using the imaging unit 10 with the vehicle 3 stopped (or moving at reduced speed, for example) for a short while at a particular position where display adjustment should be performed (at a location where display adjustment should be performed), and adjusts the display mode of the display unit 30 while referring to the peripheral image of the vehicle 3 taken by the imaging unit 10. Nevertheless, a location where the vehicle 3 is parked or moving is a location such as a road that requires a certain amount of caution in terms of safety. Thus, while it is desirable that the vehicular display device 1 adjusts the display state of the display unit 30 at such a location, often performing adjustment at that location is substantially difficult from the standpoint of safety.

Here, in this embodiment, the vehicular display device 1 takes an image of the periphery of the vehicle 3 using the imaging unit 10 in a short period of time, for example, after the vehicle is temporarily stopped (or reduced in speed) at a particular position (a location having a landscape that makes it easy to adjust the display state of the display unit 30, for example). Then, the vehicular display device 1 temporarily stores the peripheral image data 9 based on the peripheral image of the vehicle 3 in the image storing unit 8. With this arrangement, the adjusting unit 4 can prioritize that image based on the peripheral image data 9 stored in the image storing unit 8 (memory) over the presently taken peripheral image in the imaging step in accordance with the set adjustment mode and display the peripheral image based on the peripheral image data 9 stored in the image storing unit 8 (memory) on the display unit 30, even when the vehicle 3 is temporarily away from that particular position. As a result, in the adjustment step, it is possible to correctly make adjustments to the display state of the display unit 30 in an unhurried manner at a safe, desirable position, for example. Note that the peripheral image data 9 stored in the image storing unit 8 may be for a static or dynamic peripheral image of the vehicle 3.

In the adjustment method of the vehicular display device 1 of the above embodiment, in terms of the contents of each step, the adjustment step features correction of the distortion of the peripheral image of the vehicle 3 displayed on the display device 30.

According to such a configuration, when the distortion of the peripheral image of the vehicle 3 taken by the imaging unit 10 (camera) is to be corrected, the need to stop the vehicle 3 for a long period of time in a location that has a landscape that makes it easy to perform display adjustment work but is not necessarily safe (particular position) is eliminated. Thus, according to such an adjustment method of the vehicular display device 1, it is possible, for example, to correctly make display adjustments related to distortion correction of the peripheral image of the vehicle 3 in an unhurried mariner at a safe location (desired position) that is suitable for display adjustment.

In the adjustment method of the vehicular display device 1 of the above embodiment, in terms of the contents of each step, the adjustment step features the adjustment of the display mode (color, brightness, and contrast, for example) of the peripheral image of the vehicle 3 taken by the imaging unit 10 (camera).

According to such a configuration, when the display mode of the peripheral image of the vehicle 3 taken by the imaging unit 10 (camera) is to be adjusted, the need to stop the vehicle 3 for a long period of time in a location (particular position) that has a landscape that makes it easy to perform display adjustment work but is not necessarily safe is eliminated. Thus, according to such an adjustment method of the vehicular display device 1, it is possible, for example, to correctly make display adjustments related to the display mode of the display unit 30 in an unhurried manner at a safe location (desired position) suitable for display adjustment.

In the adjustment method of the vehicular display device 1 of the above embodiment, in terms of the contents of each step, the above-described adjustment step features selective execution of subsequent adjustment mode where, after an image of the periphery of the vehicle 3 is taken by the imaging unit 10, the vehicle 3 is moved from that particular position to a desired position where display adjustment is performed by the adjusting unit 4, and immediate adjustment mode where, after an image of the periphery of the vehicle 3 is taken by the imaging unit 10, display adjustment is performed by the adjusting unit 4 (adjusting unit) at that particular position as is.

According to such a configuration, in the adjustment step, the adjusting unit 4 can perform display adjustment in a location (particular position) suitable for performing display adjustment work as is, or perform display adjustment after the vehicle 3 has been moved from a particular position that is not necessarily safe to a safe, desirable position suitable for performing display adjustment, as needed based on mode selection. That is, the adjusting unit 4 makes it possible to set the mode to subsequent adjustment mode, move the vehicle 3 from a particular position that is not necessarily safe to a safe, desirable position, and correctly perform display adjustment of the display device 30 in an unhurried manner in a case where the vehicle 3 cannot be stopped for a long period of time, for example. On the other hand, the adjusting unit 4 also makes it possible to set the mode to immediate adjustment mode and quickly perform display adjustment of the display device 30 at that location in a case where the vehicle 3 can be stopped for a long period of time, for example.

The vehicular display device 1 of the above embodiment comprises the imaging unit 10 (camera) configured to take an image of the periphery of the vehicle at a particular position, the image storing unit 8 (memory) configured to temporarily store the peripheral image data 9 based on the peripheral image of the vehicle 3 taken by the imaging unit 10, the adjusting unit (adjusting unit 4) configured to adjust the display state of the display unit 30, the setting unit 6 (computing unit) configured to set the adjustment mode of the adjusting unit, and the display control unit 6 (computing unit) configured to give priority to peripheral image based on peripheral image data stored in the image storing unit 8 over the peripheral image taken by the imaging unit 10 in accordance with the adjustment mode set and perform control so as to display the peripheral image based on the peripheral image data 9 stored in the image storing unit 8 on the display means 30.

According to such a configuration, the vehicular display device 1 takes an image of the periphery of the vehicle 3 using the imaging unit 10 in a short period of time, for example, after the vehicle 3 is temporarily stopped (or reduced in speed) at a particular position (a location having a landscape that makes it easy to adjust the display state of the display unit 30, for example). Then, the vehicular display device 1 temporarily stores the peripheral image data 9 based on the peripheral image of the vehicle 3 in the image storing unit 8. With this arrangement, the adjusting unit 4 can prioritize the peripheral image based on the peripheral image data 9 stored in the image storing unit 8 (memory) over the peripheral image presently taken by the camera 10 in accordance with the set adjustment mode and display the peripheral image based on the peripheral image data 9 stored in the image storing unit 8 (memory) on the display unit 30, even when the vehicle 3 is temporarily away from that particular position. As a result, the computing unit 6 makes it possible to correctly make adjustments to the display state of the display unit 30 in an unhurried manner at a safe, desirable position, for example, using the adjusting unit 4.

In the vehicular display device 1 of the above embodiment, the adjusting unit 4 in the above configuration features correction of the distortion of the peripheral image displayed on the display unit 30.

According to such a configuration, when the distortion of the peripheral image of the vehicle 3 taken by the imaging unit 10 (camera) is to be corrected, the need to stop the vehicle 3 for a long period of time in a location that has a landscape that makes it easy to perform display adjustment work but is not necessarily safe (particular position) is eliminated. Thus, the vehicular display device 1 makes it possible, for example, to correctly make display adjustments related to distortion correction of the peripheral image of the vehicle 3 in an unhurried manner at a safe location (desired position) suitable for display adjustment.

In the vehicular display device 1 of the above embodiment, the adjusting unit 4 in the above configuration features adjustment of the display mode (color, brightness, and contrast, for example) of the peripheral image displayed on the display unit 30.

According to such a configuration, when the display mode of the peripheral image of the vehicle 3 taken by the imaging unit 10 (camera) is to be adjusted, the need to stop the vehicle 3 for a long period of time in a location (particular position) that has a landscape that makes it easy to perform display adjustment work but is not necessarily safe is eliminated. Thus, the vehicular display device 1, for example, correctly performs display adjustment related to the display mode of the display unit 30 in an unhurried manner at a safe location (desired position) suitable for display adjustment.

In the vehicular display device 1 of the above embodiment, the computing unit 6 (display control unit) in the above configuration features control that selectively executes subsequent adjustment mode where, after an image of the periphery of the vehicle 3 has been taken by the imaging unit 10, the vehicle 3 is moved from that particular position to a desired position where display adjustment by the adjusting unit 4 is performed, and immediate adjustment mode where, after an image of the periphery of the vehicle 3 has been taken by the imaging unit 10, display adjustment by the adjusting unit 4 is performed at that particular position as is.

According to such a configuration, in the adjustment step, the adjusting unit 4 can perform in accordance with the conditions of the periphery of the vehicle 3 display adjustment in a location (particular position) suitable for performing display adjustment work as is, or perform display adjustment after the vehicle 3 has been moved from a particular position that is not necessarily safe to a safe, desirable position suitable for performing display adjustment, as needed based on mode selection. That is, the adjusting unit 4 makes it possible to set the mode to subsequent adjustment mode, move the vehicle 3 from a particular position that is not necessarily safe to a safe, desirable position, and correctly perform display adjustment of the display device 30 in an unhurried manner in a case where the vehicle 3 cannot be stopped for a long period of time, for example. On the other hand, the adjusting unit 4 also makes it possible to set the mode to immediate adjustment mode and quickly perform display adjustment of the display device 30 at that location in a case where the vehicle 3 can be stopped for a long period of time, for example.

Note that this embodiment is not limited to the above, and various modifications are possible. In the following, details of such modifications will be described one by one.

While the above embodiment has been described in connection with an illustrative scenario using distortion correction, etc., of the rearward image of the vehicle 3 as the content of display adjustment, display adjustment is not limited thereto and other content may also be adjusted. Further, while the above embodiment has been described in connection with an illustrative scenario where the vehicular display device 1 takes an image of the view behind the vehicle 3 using the camera 10 installed to the rear upper area of the vehicle 3, the present invention is not limited thereto. That is, the vehicular display device 1 may take an image of the side view of the vehicle 3 using the camera 10 installed to a side of the vehicle 3, for example, or of the front view of the vehicle 3 using the camera 10 installed to the front of the vehicle 3.

1-8. (canceled)

9. A vehicular display device adjustment method, comprising:
an imaging step of taking an image of the periphery of a vehicle using an imaging unit, at a particular position where said vehicle is to start backing up toward a parking space that exists behind said vehicle;
an image storing step of temporarily storing in an image storing unit peripheral image data based on a peripheral image of said vehicle taken by said imaging unit;
a setting step of setting an adjustment mode for adjusting a display state of a display unit;
a display control step of giving priority to said peripheral image based on peripheral image data stored in said image storing unit over said peripheral image taken in said imaging step in accordance with the adjustment mode set, and displaying said peripheral image based on the peripheral image data stored in the image storing unit on said display unit; and
an adjustment step of adjusting a display state achieved of said display unit based on said peripheral image; wherein:
said adjustment step selectively executes a subsequent adjustment mode where, after an image of the periphery of said vehicle has been taken by said imaging unit, said vehicle is moved from said particular position to a desired position located at a predetermined distance away from said particular position where display adjustment of said adjustment step is performed, and an immediate adjustment mode where, after an image of the periphery of said vehicle has been taken by said imaging unit, display adjustment of said adjustment step is performed at said particular position as is.

10. The vehicular display device adjustment method according to claim 9, wherein:
said adjustment step corrects distortion of said peripheral image displayed on said display unit.

11. The vehicular display device adjustment method according to claim 9, wherein:
said adjustment step corrects a display mode of said peripheral image displayed on said display unit.

12. The vehicular display device adjustment method according to claim 9, wherein:
said adjustment step, in a case where the current mode is assessed as said subsequent adjustment mode based on a setting of a first flag that manages a setting indicating whether the mode is said immediate adjustment mode or said subsequent adjustment mode, selects and displays a peripheral image taken at said particular position in past times or a peripheral image newly taken at said particular position, as an image that should be displayed when performing display adjustment, in accordance with a setting of a second flag for setting an image that should be displayed when said vehicle is moved from said particular position to said desired position and said display adjustment is subsequently performed.

13. A vehicular display device comprising:
an imaging unit configured to take an image of the periphery of a vehicle at a particular position where said vehicle is to start backing up toward a parking space that exists behind said vehicle;
an image storing unit configured to temporarily store peripheral image data based on a peripheral image of said vehicle taken by said imaging unit;
an adjusting unit configured to adjust a display state of a display unit;
a setting unit configured to set an adjustment mode of said adjusting unit; and
a display control unit configured to give priority to said peripheral image based on peripheral image data stored in said image storing unit over said peripheral image taken by said imaging unit in accordance with the adjustment mode set and perform control so as to display the peripheral image based on the peripheral image data stored in the image storing unit on said display unit, wherein:
said adjustment unit selectively executes a subsequent adjustment mode where, after an image of the periphery of said vehicle has been taken by said imaging unit, said vehicle is moved from said particular position to a desired position located at a predetermined distance away from said particular position where display adjustment is performed, and an immediate adjustment mode where, after an image of the periphery of said vehicle has been taken by said imaging unit, display adjustment is performed at said particular position as is.

14. The vehicular display device according to claim 13, wherein:
said adjusting unit corrects distortion of said peripheral image displayed on said display unit.

15. The vehicular display device according to claim 13, wherein:
said adjusting unit corrects a display mode of said peripheral image displayed on said display unit.

16. The vehicular display device according to claim 13, wherein:
said adjusting unit, in a case where the current mode is assessed as said subsequent adjustment mode based on a setting of a first flag that manages a setting indicating whether the mode is said immediate adjustment mode or said subsequent adjustment mode, selects and displays a peripheral image taken at said particular position in past time or a peripheral image newly taken at said particular position, as an image that should be displayed when performing display adjustment, in accordance with a setting of a second flag for setting an image that should be displayed when said vehicle is moved from said particular position to said desired position and said display adjustment is subsequently performed.
